(19) United States
(12) Patent Application Publication
(10) Pub. No.: US 2012/0247002 A1
(43) Pub. Date: Oct. 4, 2012

(54) PROCESS FOR PREPARING A FUEL FOR AUTOMOTIVE APPLICATIONS, STATIONARY ENGINES AND MARINE APPLICATIONS BY CATALYTIC LIQUID PHASE ALCOHOL CONVERSION AND A COMPACT DEVICE FOR CARRYING OUT THE PROCESS

(76) Inventors: Christophe Duwig, Malmo (SE); Pär Gabrielsson, Helsingborg (SE); Ton X. Janssens, Bagsvaerd (DK)

(21) Appl. No.: 13/269,384

(22) Filed: Oct. 7, 2011

(30) Foreign Application Priority Data
Apr. 1, 2011 (DK) PA2011 00243

(51) Int. Cl. C10L 1/182; B01J 14/00

(52) U.S. Cl. 44/446; 422/198

(57) ABSTRACT

A fuel for automotive applications, stationary engines and marine applications is prepared by catalytic liquid phase conversion of the alcohol(s) of an alcohol-containing primary fuel to the corresponding ether(s) in a compact device comprising an inlet for an alcohol-containing fuel from the primary tank, a start-up heater, a heat exchanger, which heats up the cold alcohol(s) to a suitable temperature before entering the reactor, a catalytic bed within the reactor, wherein the alcohol(s) is/are partly converted to ether(s), a pressure reduction valve, inlet means for adding additives and a buffer tank, wherein the resulting fuel mixture of alcohol(s) and ether(s) is stored after passing back through the heat exchanger for suitable cooling, the heater only being used during start-up and the process thereby being conducted under auto-thermal operation conditions.

### BACKGROUND OF THE INVENTION

1. Field of the Invention

The present invention relates to a process for preparing a fuel for automotive applications, stationary engines and marine applications by catalytic liquid phase conversion of the alcohol(s) in an alcohol-containing fuel, referred to as a bio fuel, to the corresponding ether(s). The invention further relates to a compact device for carrying out the process.

2. Description of the Related Art

At present a sustainable and generalized utilization of bio fuel is possible with second generation bio fuels. However, these bio fuels may have a lower grade in the “raw” state, and they are often unable to burn satisfactory in traditional engines. In particular, the high water content of bio ethanol limits its use for transportation and requires an energy-consuming distillation stage to remove the excess water. Furthermore, bio fuels often suffer the disadvantage of low cetane numbers, and they are not suitable for diesel engine operation unless expensive additives are added, which in turn limits the use of the alcohol-containing bio fuels to spark ignited low efficiency engines. This fact emphasizes the need for developing engineering solutions allowing a simple and cost-effective upgrading of alcohol-containing fuels to make them useful for efficient diesel operation.

### SUMMARY OF THE INVENTION

The present invention complies with this need by providing a process for preparing an automotive fuel, especially for use in diesel engines, by catalytic conversion of alcohol(s) in a bio fuel to the corresponding ether(s). More specifically, the invention concerns a process for preparing a fuel for automotive applications, stationary engines and marine applications by catalytic liquid phase conversion of the alcohol(s) of an alcohol-containing primary fuel to the corresponding ether(s), the process comprising the following steps:
(a) suitable heating of the alcohol(s) by passage through a heat exchanger,
(b) treatment of the heated alcohol(s) by passage through a catalyst bed under an adjusted temperature and at a controlled flow rate, whereby the alcohol(s) is/are partly converted to the corresponding ether(s), resulting in a fuel mixture containing alcohol(s) and ether(s) in the desired proportions and also containing water,
(c) cooling the resultant water-containing mixture of alcohol(s) and ether(s) by passing it through the above heat exchanger in the opposite direction of the primary fuel flow and
(d) optionally adding selected additives to the mixture, thereby obtaining a water-containing fuel mixture of alcohol(s) and ether(s) under auto-thermal operation conditions, said fuel mixture having specific features for a given application.

Furthermore, the invention provides a cheap compact device for carrying out the process. This compact device is a quasi-autothermal converter, which makes it possible to upgrade lower-grade bio fuels (containing alcohol) to effective fuels for use in diesel engines.

### FURTHER BACKGROUND OF THE INVENTION

The basic diesel engine (invented by Rudolf Diesel) has undergone constant improvements since its birth back in 1893. The engine efficiency has increased dramatically over the years, and because of the ability of the diesel engine to run on clean bio fuel the future prospects for the diesel engine are much brighter than those for its counterpart, the gasoline-fuelled spark ignition engine. Concerns for human health and global environmental changes due to the gases and solid particulate matter associated with fuel combustion are of increasing international attention and concern. More specifically, the amount of particulate matter and oxides of nitrogen and sulphur is a problem even for modern diesel engines. Non-combusted fuel and carbon monoxide pose another negative environmental and human influence. It is therefore of utmost importance, both from an environmental point of view and because of the increasing oil shortage, to make diesel engines run efficiently on non-fossil fuels.

It is well-known that alcohols (e.g. methanol and ethanol) are poor fuels when used in compression ignition engines. Indeed, they have inferior cetane numbers (ethanol has a cetane number below 5, and for methanol it is even lower).

However, it is also well-known that an addition of ether in the right quantity (giving e.g. methanol/DME (dimethyl ether) mixtures) can overcome this limitation. For dimethyl ether the cetane number is above 55, and for diethyl ether it is much higher (above 125). By mixing an alcohol, such as methanol or ethanol, and an ether, such as dimethyl ether or diethyl ether, in optimal proportions, an efficient and very clean operation of diesel engines may thus be obtainable.

There are, however, certain practical issues to deal with. First of all, diethyl ether is presently not available in any distribution network, and moreover the use of diethyl ether and other ethers as automotive fuel is subject to relatively stringent safety limitations, including the use of a pressurized fuel tank. To overcome these limitations the requisite ether in the alcohol/ether mixture should be provided on-board by in situ conversion of some of the alcohol to the corresponding ether. To provide the ether onboard it is necessary to have a compact device, which can be mounted compatibly on the engine. The present invention fulfils this need by providing a compact device, which is a quasi-autothermal converter supplemented with a heat exchanger and a buffer tank that can be mounted on or integrated in the engine.

The fuel mixture resulting from the alcohol conversion in the device consists at least of the ether(s) produced by the alcohol conversion, residual alcohol and water. This fuel mixture is referred to as an On-Board Alcohol To Ether (OBATE) fuel. The OBATE fuel can be used directly as it is, i.e. it is not necessary to remove the water prior to use.

On the contrary, the presence of some water surprisingly is beneficial because it has a diluting effect on the very reactive ethers, especially diethyl ether, and also a certain influence on the combustion by limiting the temperature rise without in any way inhibiting the combustion.

A number of procedures and devices dealing with conversion of alcohols to ethers for automotive purposes are described in the prior art. Thus WO 01/02515 (Haldor Topsoe A/S) regards continuous dehydration of alcohol to ether and water used as fuels for diesel engines. It describes the alcohol-to-ether conversion principle, but is silent as to a compact device with heat exchanger and buffer tank to be combined with the engine. U.S. Pat. No. 4,422,412 (AECI Ltd.) covers a system without heat exchanger and buffer tank, that injects directly in the cylinder. Unlike the device according to the invention, which contains a buffer tank that can be connected to the common-rail injection system, this is a system working under very high pressure. Further, it does not operate auto-thermally by recuperating the heat from the fuel containing ether. U.S. Pat. No. 4,876,989 (Technology Development Associates, Inc.) describes a method for enhancing the performance of an alcohol fuelled engine during cold conditions. The method comprises a gas phase reaction for start-up improvement. EP 0 419 743 (Her Majesty the Queen in Right of New Zealand) describes a fuel supply and control system for compression ignition engines. Only a part of the alcohol is used for upgrade (ether pilot fuel), and the reaction is run in gas phase to condense out water and alcohol, thereby obtaining pure ether for pilot injection. U.S. Pat. No. 6,340,003 (Haldor Topsoe A/S) concerns a method for operating a compression engine on dimethyl ether at high pressure, using exhaust gas to heat up. The use of lower ethers as diesel fuel is also described in U.S. Pat. No. 4,892,561 (Irving E. Levine) and U.S. Pat. No. 5,906,664 (Amoco Corp.). An ethanol fuel reforming (improperly called so, since reforming would convert the alcohol to H₂ and CO) system for internal combustion engines is described in US 2008/0282998 (Honda Motor Co. Ltd.). The system uses an indirect heating from the exhaust gas, the intermediate fluid heating up the alcohol and cooling down the reaction. US 2006/0180099 (Honda Motor Co. Ltd.) provides a method for controlling a compression ignition internal combustion engine, but it is silent as to the device or system to work the method, which incidentally uses two fuels instead of one. Finally, US 2011/005501 (MAN Nutzfarzeuge AG) relates to a self-igniting internal combustion engine with ether fumigation of the combustion air for vehicles. The exhaust gas is used to vaporize and heat-up the alcohol before injection in the cylinder as fumigation.

While the above-cited prior art generally deals with the fact that alcohols and ethers are promising fuels for automotive engines, none of the references mention or disclose a compact device in the shape of a quasi-autothermal converter supplemented with a heat exchanger and a buffer tank that can be mounted directly on the engine.

Traditionally, the production of diethyl ether is performed under a moderate pressure (around 20 bars) by dehydration of ethanol over a suitable catalyst. If this procedure is to be performed on-board, it would imply (1) evaporating the ethanol-containing fuel, (2) performing the conversion to diethyl ether, (3) condensing the products and (4) further compressing the mixture before injection into the engine. It would therefore be desirable to work solely in liquid phase using a more compact and operation-efficient device.

The present invention provides a surprisingly compact and integratable device for this purpose, the device performing the conversion of alcohol (such as ethanol) into ether (such as diethyl ether) for automotive applications, stationary engines and marine applications. The device according to the invention operates in an auto-thermal mode, so that heat neither has to be added nor removed during steady operation, which contributes to the compactness of the device. In other words, the device makes use of “cold” alcohol from the primary fuel tank and delivers a “cold” ether-containing mixture for compression and injection into the engine.

Another reason why it is possible to make the design so compact is that it is not necessary to remove the water from the produced OBATE fuel prior to use. As already mentioned the presence of water is even advantageous because of the useful influence of the water on the combustion.

### BRIEF DESCRIPTION OF THE DRAWINGS

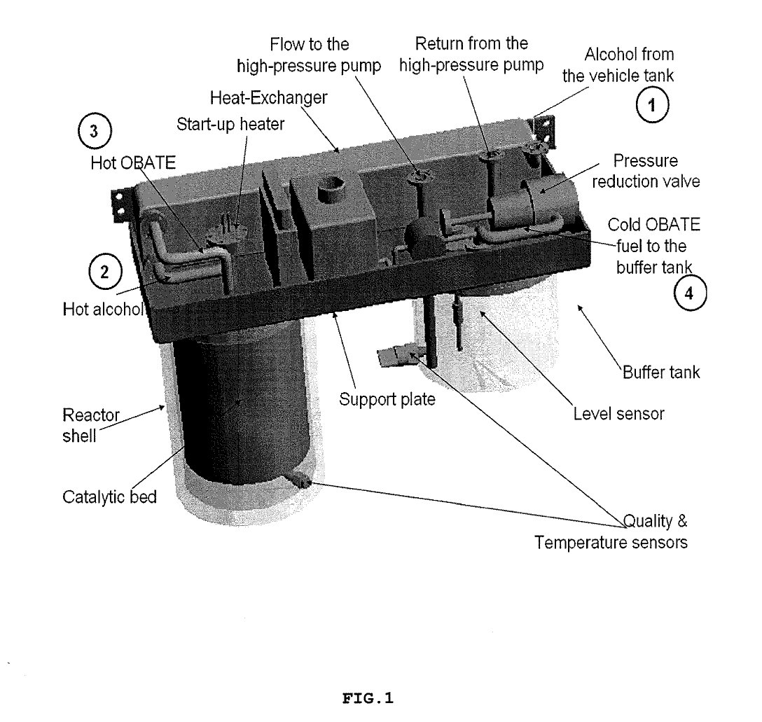

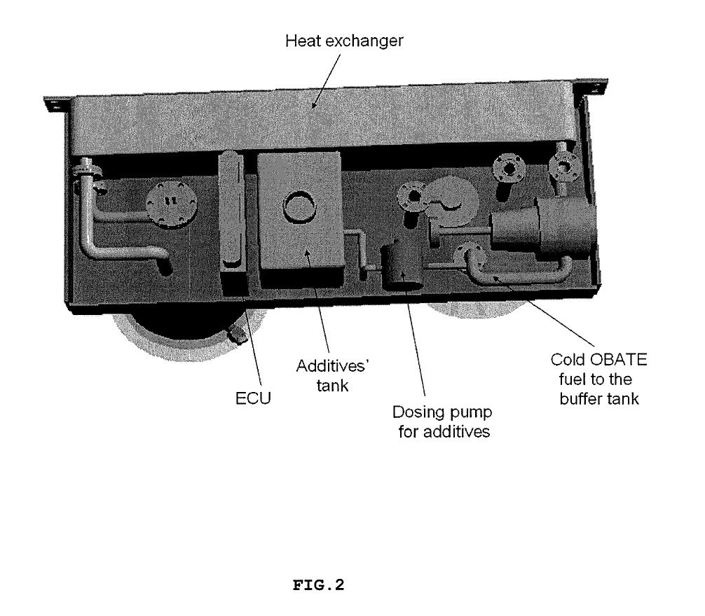

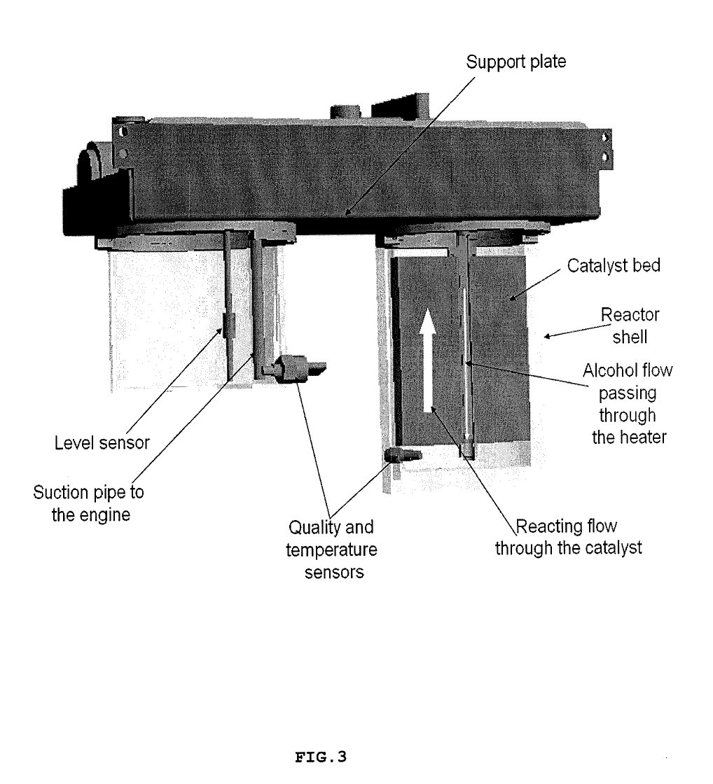

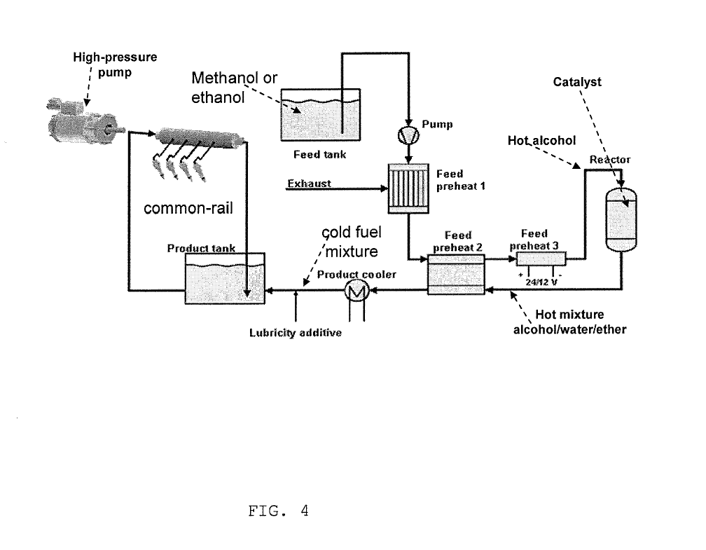

The device according to the invention is illustrated in FIGS. 1-3 showing a preferred embodiment of the device from different angles. FIG. 4 is a flow sheet showing the principle of integrating the device in an engine.

### DETAILED DESCRIPTION OF THE INVENTION

The device according to the invention consists of:
an inlet for an alcohol-containing fuel from the primary tank,
a start-up heater initially heating up the catalyst bed or alternatively the flow downstream of the heat exchanger,
a heat exchanger, which heats up the cold alcohol(s) to a suitable temperature prior to reaction,
a reactor,
a catalytic bed within the reactor, wherein the alcohol(s) is/are partly converted to ether(s) and water,
a pressure reduction valve,
inlet means for adding additives and
a buffer tank, wherein the resulting fuel mixture of alcohol(s), ether(s) and water is stored after passing back through the heat exchanger for suitable cooling,
   the heater only being used during start-up and the process thereby being conducted under auto-thermal operation conditions.

The focus of the idea underlying the present invention is (i) to recover the heat after the catalytic reaction in the reactor and use it to heat up the alcohol(s) from the primary fuel tank (i.e. an auto-thermal operation) and (ii) to have a buffer tank, which is used when adding additives (such as lubricants), which can be connected to a common-rail (return lines) and which can be used to start up the engine prior to starting the converter.

The compact device that performs the liquid phase process according to the invention is illustrated on the FIGS. 1-3 showing a preferred embodiment of the device. For a steady state operation the following steps are conducted (see the numbers 1 to 4 in circles on FIG. 1): (1) The alcohol from the primary fuel tank of the vehicle enters the system via the alcohol inlet, passes through the heat exchanger and exits the heat exchanger at a suitable temperature. (2) From there, the heated alcohol enters the reactor, flows down the central tube and up through the catalyst bed, where it is partially converted to the corresponding ether by dehydration. The reactions are:

2CH₃OH [symbol] CH₃—O—CH₃+2H₂O for methanol-containing primary fuel and

2CH₃CH₂OH [symbol] CH₃CH₂—O—CH₂CH₃+2H₂O for ethanol-containing primary fuel.

Suitable dehydration catalysts for use in the process and the device according to the invention comprise solid acids, such as alumina, silica alumina, zeolites, tungstated or sulfated oxides, alumina phosphates, materials containing sulfonic acid functional groups, such as sulfonated polystyrene, sulfonated fluorocarbon polymers, sulfonic acid functionalized oxide materials (alumina, SBA-15, silica) and mixtures thereof.

(3) The resulting mixture leaving the reactor constitutes the OBATE fuel. The degree of conversion is set by adjusting the temperature in the reactor as well as the flow of fuel.

(4) Upon leaving the reactor, the hot OBATE fuel is cooled down by passing back through the heat exchanger in the reverse direction of the incoming cold alcohol-containing primary fuel, transferring the heat thereto. The cooled OBATE fuel then passes through the pressure reduction valve. Additives can be supplemented to the fuel before it is stored in the buffer tank. The respective operating pressures of the reactor and the buffer tank are different, enabling reactions at relatively high pressures and at the same time allowing a light buffer tank.

At start-up the reactor is cold, and the heat exchanger therefore cannot provide sufficient heating, so an electric start-up heater is used to pre-heat the cold alcohol(s) before passing through the catalyst bed. Once the steady state has been reached, the start-up heater is turned off. During operation of the device the conversion rate in the catalytic bed is monitored by the quality and temperature sensors. The conversion rate is controlled by adjusting the alcohol flow as well as the pre-heating temperature via the electric heater.

The cold OBATE fuel is temporarily stored in the buffer tank, from where it is fed to the injector or common-rail. A return flow is allowed, whereby it is possible to recycle a surplus of fuel if the mass flow is larger than the engine can consume.

FIG. 4 outlines how the device according to the invention can be integrated in an existing vehicle engine. As shown on the Fig. the alcohol-containing fuel can be preheated by the exhaust of the engine before passing through the heat exchanger, and excess OBATE fuel may be returned from the common-rail of the engine to the buffer tank.

In summary, the advantages of the process and the device according to the invention are as follows:
The conversion is done solely in liquid phase, so there is no need to evaporate reactants or to condense the products. The recovery of heat enables an auto-thermal operation. No additional heat is needed to pre-heat the alcohol, except at start-up from cold.
The compact integrated design of the device enables the conversion in an auto-thermal mode.
It is not necessary to remove water from the produced fuel mixture prior to use, which further enables a compact design.
Only fuel containing alcohol is stored in the primary fuel tank.
The buffer tank makes it possible to handle an uneven or unsteady fuel consumption as well as the return flow from the common-rail of the engine.
The buffer tank makes it possible to handle an unsteady fuel consumption when used with unit injectors.
A moderate heat input for start-up is compatible with electric heating using the battery of the vehicle. The operation is auto-thermal the rest of the time.
The buffer tank allows starting the engine without operating the reactor. Hence one may use the engine to produce electricity for start-up (heating) of the fuel upgrade reactor, i.e. start-up without using the battery of the vehicle.
Efficient and easy control of the dehydration reaction using the electric heater and adjusting the flow through the reactor.

The invention is further illustrated by the following working example.

### EXAMPLE

The reactor containing a catalyst bed is operated at an inlet temperature of 220° C. and under a pressure of 60 bars. The primary fuel is wet ethanol (5 wt % water), and the fuel flow is adjusted to reach a conversion degree of 70% with the present catalyst mass. The primary fuel exits the primary fuel tank at approximately 20° C. and passes through the heat exchanger, which is designed for pre-heating the primary fuel up to 220° C. (no need of the electric start-up heater at this stage). The hot primary fuel passes through the catalyst bed, whereby 70% of the ethanol is converted to diethyl ether. The reaction is exothermic, and the OBATE fuel mixture reaches a temperature of 236° C. During its subsequent passage through the heat-exchanger the fuel mixture is cooled down to approximately 50° C. The pressure of the OBATE stream is reduced to about 5 bars and some lubrication medium is added prior to storage of the mixture in the buffer tank.

What is claimed is:

1. A process for preparing a fuel for automotive applications, stationary engines and marine applications by catalytic liquid phase conversion of the alcohol(s) of an alcohol-containing primary fuel to the corresponding ether(s), said process comprising the following steps:
(e) suitable heating of the alcohol(s) by passage through a heat exchanger,
(f) treatment of the heated alcohol(s) by passage through a catalyst bed under an adjusted temperature and at a controlled flow rate, whereby the alcohol(s) is/are partly converted to the corresponding ether(s), resulting in a fuel mixture containing alcohol(s) and ether(s) in the desired proportions and also containing water,
(g) cooling the resultant water-containing mixture of alcohol(s) and ether(s) by passing it through the above heat exchanger in the opposite direction of the primary fuel flow and
(h) optionally adding selected additives to the mixture, thereby obtaining a water-containing fuel mixture of alcohol(s) and ether(s) under auto-thermal operation conditions, said fuel mixture having specific features for a given application.

2. Process according to claim 1, wherein the alcohol is ethanol and the ether is diethyl ether.

3. Process according to claim 1, wherein the alcohol is methanol and the ether is dimethyl ether.

4. A device for carrying out the process of the preceding claims, said device consisting of:
an inlet for an alcohol-containing fuel from the primary tank,
a start-up heater initially heating up the catalyst bed or alternatively the flow downstream of the heat exchanger,
a heat exchanger, which heats up the cold alcohol(s) to a suitable temperature prior to reaction,
a reactor,
a catalytic bed within the reactor, wherein the alcohol(s) is/are partly converted to ether(s) and water,
a pressure reduction valve,
inlet means for adding additives and
a buffer tank, wherein the resulting fuel mixture of alcohol(s), ether(s) and water is stored after passing back through the heat exchanger for suitable cooling,
the heater only being used during start-up and the process thereby being conducted under auto-thermal operation conditions.

5. The device according to claim 4, wherein the catalytic bed is an alcohol dehydration catalyst arranged as a fixed bed in the reactor.
